(19) United States
(12) Patent Application Publication
(10) Pub. No.: US 2012/0323654 A1
(43) Pub. Date: Dec. 20, 2012

(54) SYSTEM AND METHOD OF MANAGING AND TRACKING A PLURALITY OF TOKENS

(75) Inventor: Gregory Writer, Escondido, CA (US)

(73) Assignee: CHILDREN'S EDUTAINMENT NETWORK, INC., ESCONDIDO, CA (US)

(21) Appl. No.: 13/162,875

(22) Filed: Jun. 17, 2011

(51) Int. Cl. G06Q 30/00; G06F 15/16

(52) U.S. Cl. 705/14.16; 709/224

(57) ABSTRACT

There is a system, a method, and a non-transitory computer readable medium configured to manage and track a plurality of exchangeable tokens. The system includes a tracking module configured to track a location of the tokens. The system includes an ID verification module configured to verify an ID of a token. The system includes an ID writing module configured to write an ID for a token. The system includes a control module configured to provide operational instructions to the modules of the system. The system also includes a communication module configured to send and receive data over a network. The system includes a reward module configured to provide a reward over a network. The system further includes a storage module configured to store data. The system includes a management module configured to manage the plurality of exchangeable tokens and metadata and ID data of the tokens over a network.

### BACKGROUND OF THE INVENTION

1. Field of the Invention

The present invention relates to systems and methods of referral marketing, specifically to a system and method of managing and tracking a plurality of tokens.

2. Description of the Related Art

Marketing is defined as an activity, a set of institutions, or a processes for creating, communicating, delivering, and exchanging offerings that have value for customers, clients, partners, and society at large. Marketing is a product or service selling related overall activities. It generates the strategy that underlies sales techniques, business communication, and business developments. It is an integrated process through which companies build strong customer relationships and create value for their customers and for themselves. Marketing data is typically tracked and reviewed by companies to understand their clients and to develop new methods to reach their target market.

Marketing is used to identify the customer, satisfy the customer, and keep the customer. With the customer as the focus of its activities, it can be concluded that marketing management is one of the major components of business management. Marketing evolved to meet the stasis in developing new markets caused by mature markets and overcapacities in the last 2-3 centuries. The adoption of marketing strategies requires businesses to shift their focus from production to the perceived needs and wants of their customers as the means of staying profitable.

The term marketing concept holds that achieving organizational goals depends on knowing the needs and wants of target markets and delivering the desired satisfactions. It proposes that in order to satisfy its organizational objectives, an organization should anticipate the needs and wants of consumers and satisfy these more effectively than competitors. Some improvements have been made in the field. Examples of references related to the present invention are described below in their own words, and the supporting teachings of each reference are incorporated by reference herein:

U.S. Pat. No. 6,222,452, issued to Ahlstrom et al., discloses an electronic identification tag is made up of at least one cover strip and a carrier strip having an antenna and transponder mounted thereon, and an adhesive to secure the strips together such that the antenna is interposed between the strips, the transponder being pre-programmed to generate a signal having a unique code correlated with indicia on the tag to identify a passenger or luggage. The tag further lends itself well to a novel method of tracking luggage and passengers in a transportation facility.

U.S. Pat. No. 6,173,267, issued to Cairns, discloses a method for providing fulfillment in a promotional contest includes providing a card in a product package marked with an internet address and a password. The purchaser of the product contacts the internet address and inputs personal information and the password to learn if the purchaser is a winner in the contest. If the purchaser is a winner, the card is sent to the company to verify the winning status before sending the prize to the purchaser.

U.S. Patent Application Publication No.: 2007/0256124, by Ih et al., discloses a collectible token data management is described, including creating a visual representation of a token, associating a data structure and data with the token, and transmitting at least a portion of the data to a receiver in response to a user input with the token.

U.S. Patent Application Publication No.: 2003/0163787, by Hay et al., discloses a virtual token represents an item, and includes embedded data defining rules and/or capabilities which apply to the use of the item. A virtual token may include graphical image data which is used to generate a display on a computer, whereby selection of the display allows the item represented by the virtual token to be used. A virtual token may contain instructions for sending access requests to a location on a communications network A system for handling virtual tokens includes a clearing and routing house for routing token access requests, authenticating and generating tokens, and maintaining container structures for tokens. The system also includes connectors installed in a communications network for creating, controlling and managing items represented by tokens, and device clients for executing token components that issue access requests to the clearing and routing house.

U.S. Patent Application Publication No.: 2002/0073015, by Chan et al., discloses an online market place bringing together owners, developers/operators, trustees, associations, and management companies of redeemable assets. Through an asset converter, redeemable assets are evaluated online or offline according to a points-based system and the value of assets are converted to digital tokens before trading takes place. A separate and independent asset validator that is linked to the asset converter, asset management companies as well as asset developers/operators acts as a caretaker in verifying the status of ownership of assets and ensures the delivery, receipt and utilization rights of the assets. Digital tokens are indicia of the value of redeemable assets and may be spent only within the market place of the present invention. As such, trading and exchange of redeemable assets among different classes and types are carried out virtually, transparently and securely.

The inventions heretofore known suffer from a number of disadvantages which include being limited in application, being limited in referring customers, being ineffective, being difficult to use, being difficult to manage, being difficult to track, being difficult to redeem, failing to promote sufficient viral behavior among purchasers, not providing sufficient after-purchase information, inducing undesired behavior, misdirecting sales behavior, being too expensive, being too complicated, and the like.

What is needed is a system and method of managing and tracking a plurality of tokens that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods of management and tracking of tokens. Accordingly, the present invention has been developed to provide a effective system and method of referral marketing using a plurality of tradable tokens.

According to one embodiment of the invention, there is a method of managing and tracking a plurality of tokens. The method may include distributing a plurality of tokens that may include a computer readable medium. Each medium may include a first token ID. The method may include receiving a first token ID and receiving user metadata from a source of the first token ID. The method may include the step of registering the user metadata in association with the first token ID and sending a second token ID to the source of the first token ID. The method may include instructing a user to share the token including the second token ID. The method may include the step of receiving the second token ID and receiving user metadata from a source of the second token ID. The method may include registering the user metadata in association with the second token ID and providing a reward to the source of the second token ID.

The method may include the step of providing a third token ID to the source of the second token ID. The method may include writing the second token ID to the computer readable medium. The method may include providing a grand prize to a source. The method may include providing a reward to the source of the first token ID after receiving user metal data from the source of the second token ID. The method may include the step of distributing the plurality of tokens with a consumer good. The method may further include the step of writing a unique token ID to the computer readable medium. The method may include associating metadata from the source of the second token ID with the metadata of the source of the first token ID.

According to one embodiment of the invention, there is a management and tracking system for a plurality of exchangeable tokens. The system may include a tracking module configured to track a location of a token. The tracking module may be in communication with the storage module and may be configured to track the location and previous locations of the token as it is exchanged. The system may include an ID verification module configured to verify an ID of a token with a token database. The ID verification module may be in communication with the reward module and may be configured to verify an ID of a token and provide a reward to a source of the token over a network. The system may also include an ID writing module configured to write an ID for a token. The ID writing module may be in communication with the communication module and may be configured to transfer a token ID to a computer readable medium. The ID writing module may be configured to write a unique grand reward ID. The system may include a control module configured to provide operational instructions to the modules of the system. The system may include a communication module configured to send and receive data over a network.

The system may include a reward module configured to provide a reward over a network. The system may also include a storage module configured to store data. The system may further include a management module configured to manage a plurality of exchangeable tokens. The management module may manage metadata and ID data of the tokens over a network. The management module may be in communication with the reward module and may be configured to provide a reward to a previous source of the token.

According to one embodiment of the invention, there is a non-transitory computer readable medium that may include instructions for performing the steps of sending a first token ID to a management and tracking system over a network. The instructions may include sending metadata to a management and tracking system over a network. The instructions may also include receiving a second token ID from a management and tracking system over a network. The instructions may include overwriting the first token ID with the second token ID and storing the second token ID. The instructions may include storing the first token ID and the second token ID. The instructions may also include receiving a unique ID.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a front elevational view of a token coupled to an article of clothing, according to one embodiment of the invention;

FIG. 2 is a top plan view of a token, according to one embodiment of the invention;

FIG. 3 is a network diagram of a system of managing and tracking a plurality of tokens, according to one embodiment of the invention;

FIG. 4 is a reward protocol flowchart, according to one embodiment of the invention;

FIG. 5 is a sequence diagram of a system of managing and tracking a plurality of tokens, according to one embodiment of the invention;

FIG. 6 is a reward protocol chart, according to one embodiment of the invention; and

FIG. 7 is a prior user reward protocol chart, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

As used herein, “metadata” is used in a general sense, including data associated in some manner with other data or with a source of the data.

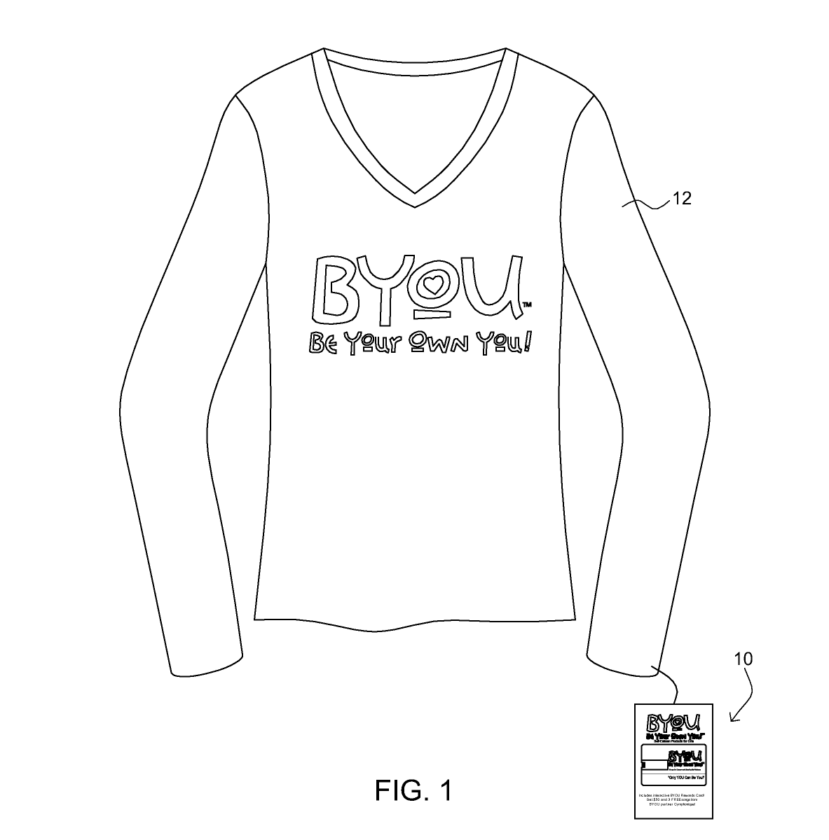

FIG. 1 is a front elevational view of a token coupled to an article of clothing, according to one embodiment of the invention. There is shown an article of clothing 12 including a token 10 coupled thereto. The illustrated token 10 is coupled to the clothing 12 by a filament, such as but not limited to a thin plastic cord terminating in a fixed coupled to each, such as but not limited to as in retail settings wherein tags such as but not limited to price tags are coupled to clothing during display. In the illustrated example, the token is branded similarly to the clothing by including a display surface having similar display characteristics to the associated article of clothing.

The illustrated token 10 is coupled to an article of clothing 12 configured for retail sale. The article of clothing 12 and the token 10 may be associated with a website or other computing resource accessible remotely over a network configured to promote marketing for the clothing line and the website. The token 10 is configured to be redeemable through the website for prizes and gifts. The website may include activities, music, games, social interaction, clothing items, etc. The token 10 is configured to be activated upon purchasing of the article of clothing 12 and configured to be exchanged for other tokens with other owners.

A token may be a physical object having a computer readable medium having data dispose thereon. The physical object may include a card, toy, irregularly-shaped object, placard, disc, coupling device, article of clothing, utensil, merchandising product, and the like and combinations thereof. The computer readable medium may include a CD, DVD, tape, USB device, solid-state memory device, hard drive, magnetic strip, bar code, 2-dimensional bar code (QR codes), and memory chip and the like and combinations thereof. The data may be stored as ROM, RAM, or the like and combinations thereof and may include identification strings, encryption, modules, functions, data structures, structured data, scripts, executable files, drivers, and the like and combinations thereof.

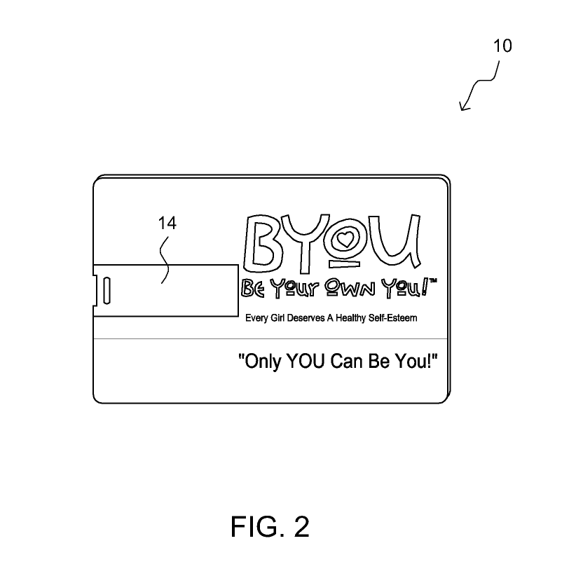

FIG. 2 is a perspective view of a token, according to one embodiment of the invention. There is shown a token 10 having a computer readable medium 14. The illustrated token is a USB card such as but not limited to a Sandisk Flash Drive produced by SanDisk Corporation, 601 McCarty Blvd, Milpitas, Calif., 95035; or a HP USB 2.0 Flash Drive produced by Hewlett Packard Company, 3000 Hanover Street, Palo Alto, Calif., 94304.

The illustrated token 10 includes a computer readable medium 14 configured to selectably couple to a computing device. The illustrated computer readable medium 14 may be inserted into a USB port of the computing device. Through data stored on the computing device and in cooperating with a separate computing device having connection to a network, the illustrated computing device may be in communication with a website through a network. The computer readable medium 14 includes a module stored therein. The module is utilized by the user to connect to the website associated with the token 10. Thereby, the token 10 may interact with the website such as but not limited to being redeemable for a monetary amount or monetary equivalent used to purchase items on the website, such as but not limited to www.ebay.com by eBay Inc. of 2065 Hamilton Ave., San Jose, Calif., 95125, www.amazon.com by Amazon of 1200 12th Ave. S., Suite 1200, Seattle, Wash., 98144, www.clubtuki.com by Children's Educational Network of 201 E. Grand Ave. Suite 2A, Escondido, Calif., 92025, and the like. The computer readable medium 14 is configured to store information such as but not limited to modules, executables, scripts, identification strings, use histories and user metadata from the purchaser of the article of clothing and pervious owners of the token 10 and the like.

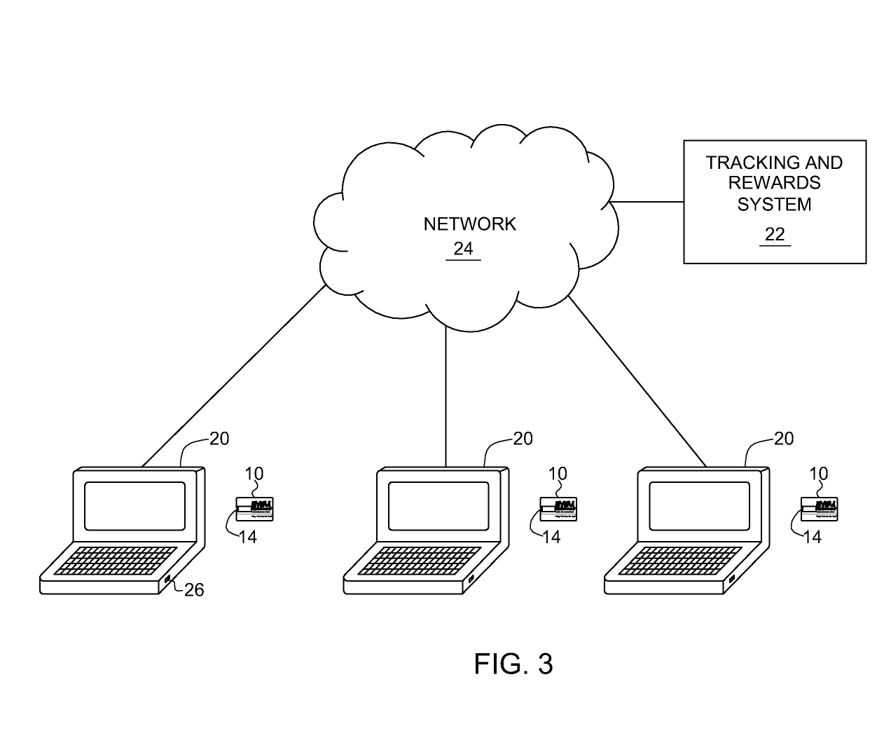

FIG. 3 is a network diagram of a system of managing and tracking a plurality of tokens, according to one embodiment of the invention. There is shown a plurality of computing devices 20 in communication with a tracking and rewards system 22 through a network 24. The illustrated network permits a plurality of users to connect with a tracking and rewards system 22 through computer interfaces, such as but not limited to computers, laptops, tablet computers, smart phones, dumb terminals, kiosks and the like and combinations thereof. Tokens may be used to initiate and to continue interaction with the system 22 and the users may also interact with the system without tokens. Such may be based on a per function basis, and/or may be a graduating set of functions, the more tokens a user processes with the system.

The illustrated network 24 is in communication with a plurality of computing devices 20. The illustrated computing devices 20 are in communication with a tracking and rewards system 22. The tracking and rewards system 22 may include a website in association with an article of clothing and a token 10, such that the website is preconfigured to interact with the token and may pass information to the producer/retailer/wholesaler/manufacturer/etc. of the article of clothing when the token is processed. The illustrated token 10 is configured to be selectably coupleable to the computing device 20. The computing device 20 includes a data port 26, such as but not limited to a USB port, card reader, scanner, serial port, parallel port, card port, data jack, RFID scanner, or the like or combinations thereof, configured to receive a computer readable medium 14 of the token 10.

The tracking and rewards system 22 may include one or more computing devices and/or may be distributed across a plurality of computing devices, such as but not limited to one or more servers. The system 22 may be distributed across a plurality of devices or systems that may be operated by one or more disparate entities, such as but not limited to manufacturers, distributors, retailers, marketing groups, content publishers, and the like and combinations thereof. The system 22 may include instructions for performing any of the steps described herein. The token may include instructions for performing any of the steps herein. Such instructions may be in the form of computer readable code such that a computing device may operate in fulfillment of the instructions. Such instructions may also include instructions that may be displayed to a user or operator of the token, associated merchandise, system, or computing device such that one or more steps may be completed manually. The tracking and rewards system 22 may be configured to store and manage information stored on each token 10. The tracking and rewards system 22 may be configured to track each code uploaded to the system 22 from each token 10. The tracking and rewards system 22 may be configured to track user metadata associated with each token 10. The illustrated tracking and rewards system 22 may be configured to verify a code stored on the token 10 and reward a user, associated with the token 10, with a monetary amount to be used to purchase prizes and gifts from a website associated with the token 10.

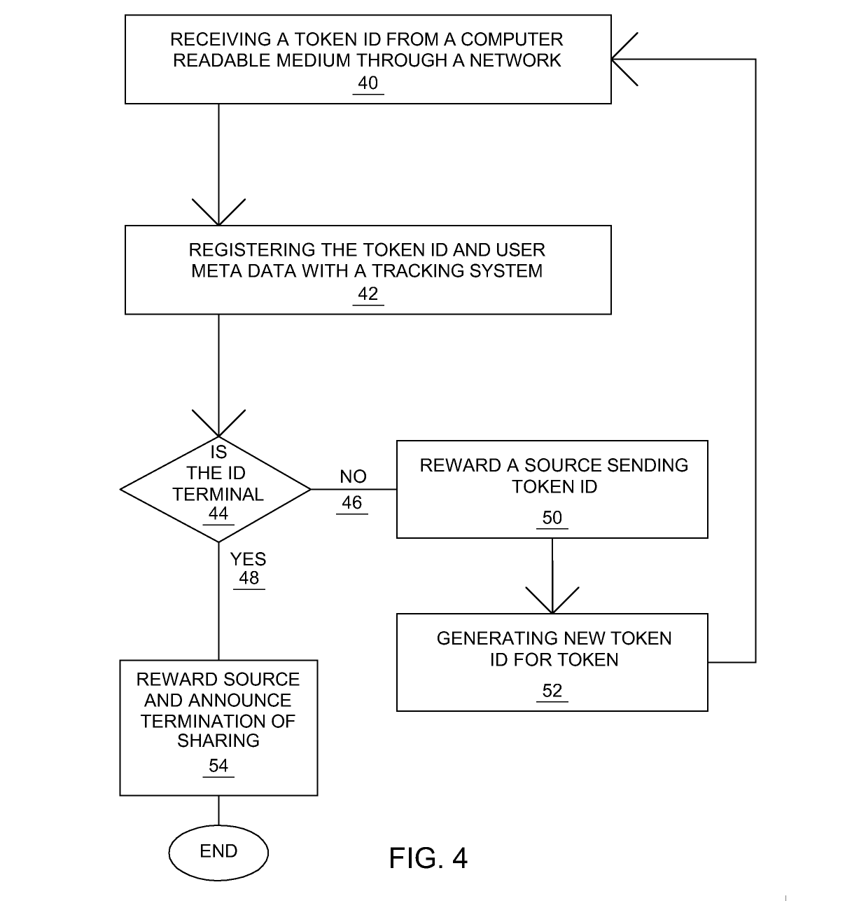

FIG. 4 is a reward protocol method diagram, according to one embodiment of the invention. There is shown a method of registering a token and rewarding a user. The illustrated method includes receiving a token ID from a user over a network, then registering the ID and checking it to see if it is “special” or “terminal,” if it is special it is treated special, of not, then it is treated “normally” and a reward is provided to the source user and then a new token ID is generated.

The illustrated method includes the step of receiving a token ID from a computer readable medium of a token, through a network 40. Such may include but is not limited to receiving a packet of information including an identification string and a source address such as but not limited to an IPv4 or IPv6 packet including a token ID.

The illustrated method includes registering the token ID with user metadata to a tracking system through the network 42. Such may include setting up a user account including information such as but not limited to: name, location, age, demographic data, preferences, social network information, association with other user accounts on the same system, association with user accounts for the same user on other systems, and the like and combinations thereof.

The tracking system verifies and stores user metadata and checks if the token ID stored on the token is terminal or otherwise special 44. Verification and/or checks may include but are not limited to checking received information against a data set (such as but not limited to a list of available token IDs or special token IDs), and calculating the validity of the token ID using a validity algorithm (such as but not limited to algorithms similar to those used to check veracity of credit card numbers such as but not limited to prefix checks, length checks, check digit algorithms, and the LUHN formula (Mod 10)). Storage may include but is not limited to writing data to a memory device, associating data with other data, and the like.

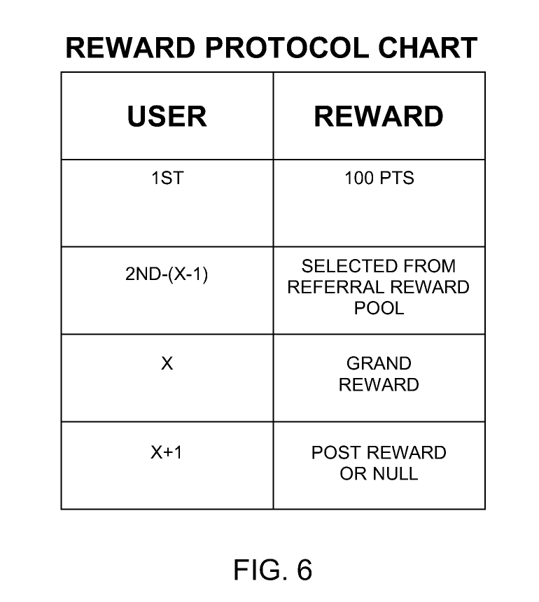

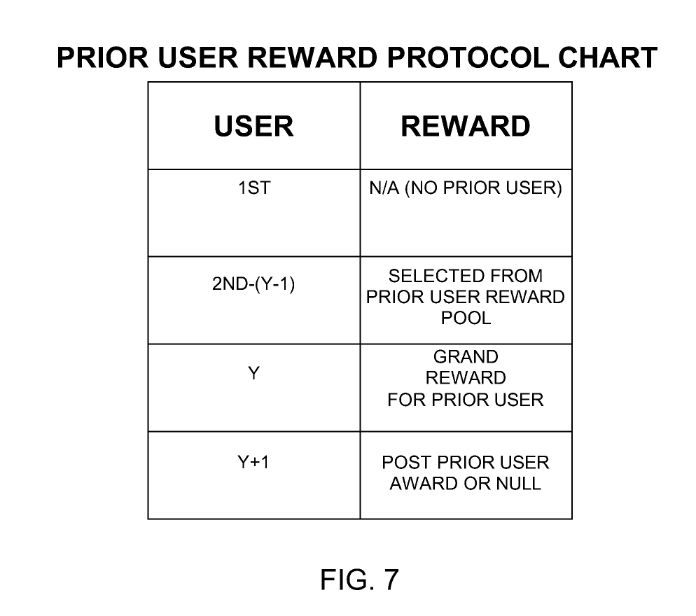

If the token ID is not special 46, the tracking system rewards the source sending the token ID 50 according to a standard process. After rewarding the source, the tracking system is configured to generate a new token ID (or a new associated token ID or change a status of the token ID, or the like or combinations thereof). Such may include transferring or writing a new token ID to the computer readable medium of the token 52. Token generation and/or reward generation may function according to one or more protocols that may follow a schedule/chart/etc. such as those described in FIGS. 6 and 7. The method may also include exchanging the token with the new token ID with other sources with other tokens and token IDs, such as but not limited to wherein users trade non-terminal tokens that have been processed through the system.

If the token ID is special 48, the tracking system performs an alternate reward protocol, such as but not limited to rewarding the source of the specific token ID with a grand prize 54. Wherein the token ID is terminal, the tracking system does not generate a new token ID and does not transfer or write a new token ID on the computer readable medium over the terminal token ID. The terminal token ID is configured to be kept and would generally be non-tradeable or not incentivized to be traded in the same sense as other tokens.

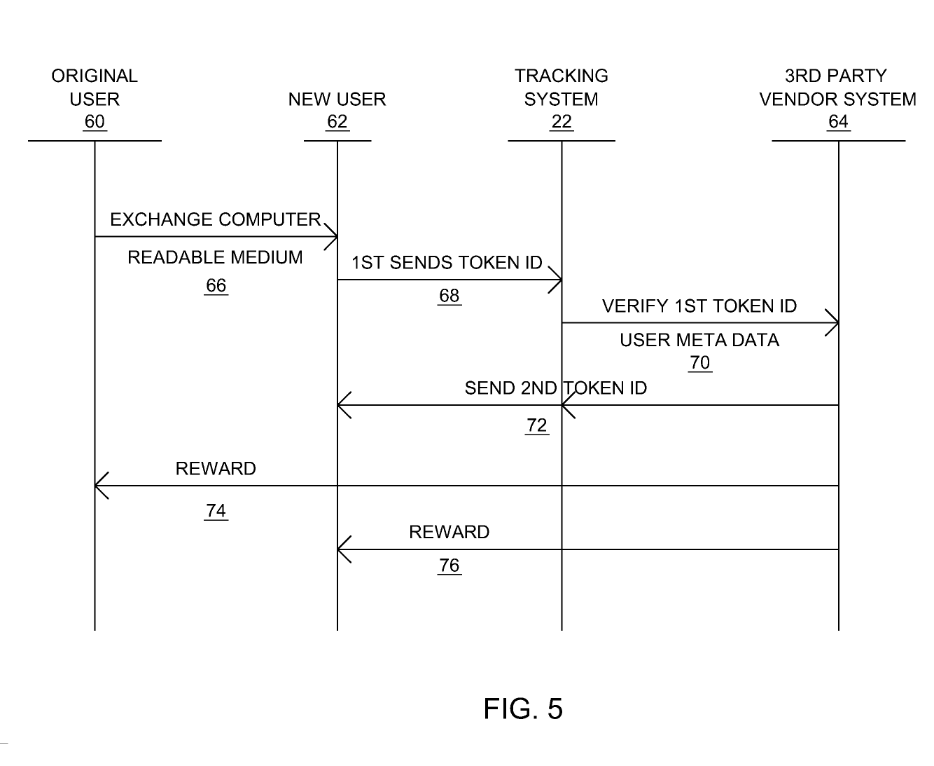

FIG. 5 is a sequence diagram of a system of managing and tracking a plurality of tokens, according to one embodiment of the invention. There is shown an original user 60, a new user 62, a tracking system 22, and a third party vendor 64 in a reward sequence diagram. The parties are communicatively coupled over a network, such as but not limited to the internet, using computing devices and information is exchanged thereby. The parties may also be coupled by other systems/devices such as but not limited to shipping networks and the like. The illustrated sequence diagrams a process that may culminate in a user receiving a reward for exchanging tokens with other users.

In the illustrated sequence the original user 60 exchanges a token including a computer readable medium 66 with a new user 62. Such may be accomplished by physically exchanging tokens, exchanging data on tokens through a data transfer between tokens, one user purchasing or otherwise acquiring a token from another user, or the like or combinations thereof.

In the illustrated sequence the new user 62 sends a token ID 68 to a tracking system 22. The new user couples the computer readable medium of the token to a computing device, by inserting the computer readable medium into a data port, such as a USB port, of the computing device. The computing device is in communication with the tracking system through a network. Non-limiting examples of a computing device may be a computer, a personal digital assistant, an iPad, a cell phone, or the like.

In the illustrated sequence the tracking system 22 verifies the token ID and metadata 70 associated with the new user 62 with a third party vendor system 64. The third party vendor system verifies the token ID with an ID database and updates and stores user metadata associated with the token ID. The ID database may be configured to store user metadata and token ID data of original users, new users, or previous users of the token. A non-limiting example of a third party vendor system may be a website affiliated with the token.

In the illustrated sequence the third party vender system 64 verifies the token ID and user metadata with a database and the third party vendor system 64 sends a second token ID 72 to the new user 62. The third party vendor system verifies the token ID and if the token ID is not terminal, the system creates and sends a new second token ID to the new user. The third party vendor system may be configured to overwrite the previous token ID on the computer readable medium and replace the first token ID with the new second token ID. The third party vendor system is configured to send the new second token ID to the tracking system for recording and then sent to the new user for use. The tracking system may be configured to send a notification to the new user to continue to exchange the token with others. Such may be accomplished by physically exchanging tokens, exchanging data on tokens through a data transfer between tokens, one user purchasing or otherwise acquiring a token from another user, or the like or combinations thereof.

In the illustrated sequence the second token ID is stored on the computer readable medium of the new user 62. The second token ID is configured to replace the first token ID on the computer readable medium. The second token ID may be configured to include user metadata, a token ID, location data, previous user data, and the like. The second token ID may be configured to overwrite the previous token ID or replace the previous token ID.

In the illustrated sequence the third party vendor system 64 is configured to send a reward to the original user 74 and send a reward to the new user 76. The reward for the new user and the original user may be a monetary reward configured to be redeemed from the third party vendor system. The reward may be associated or affiliated with a system not including the third part vendor system. The reward may be a prize, gift, gift card, tokens, coupons, vouchers, certificates, and the like.

In operation of one embodiment of the invention, there is a method of managing and tracking a plurality of tokens. The method includes distributing a plurality of tokens that include a computer readable medium. The tokens may be attached to a consumer product or article of clothing configured for retail sale. The computer readable medium is configured to be in communication with a tracking and reward system through a network. The tracking and reward system may be association with a third party vendor system having a user interactive social network environment over a network. Each medium includes a first token ID. The token ID may be a code stored within the computer readable medium of the token. The user couples the computer readable medium to a computing device. The computing device is in communication with the tracking and reward system through a network. The tracking and reward system receives the first token ID and verifies the token ID with a third party vendor system.

The source of the first token ID registers an account with the tracking and reward system and the third party vendor system. The source enters user metadata in association with the first token ID. The source is enabled with the account to navigate and interact with other users in the interactive social network environment over a network. The third party vendor system sends a second token ID to the source of the first token ID. The second token ID is stored on the computer readable medium of a token. The second token ID overwrites the first token ID, and user metadata of the first token ID, along with the first token ID and the second token ID are stored on the computer readable medium. The user is instructed to share or exchange the token including the second token ID with another user.

In one embodiment of the invention, the tracking and reward system receives a second token ID from a new user. The tracking and reward system verifies the second token ID with the third party vendor system. The new user registers and sends user metadata to the third party vendor system. The new user may already have an account with the third party vendor system and instead of registering for a new account, updates an existing account. The third party vendor system, after verification of the second token ID, sends a reward to an original source of the first token ID and the source of the second token ID.

In one embodiment of the invention, there is a third token ID disposed on a computer readable medium of a token. The third token ID is coupled to a computing device. The computing device is in communication with a tracking and reward system and a third party vendor system. The tracking and reward system receives the third token ID over a network and verifies the code with the third party vendor system. The source of the third token ID registers with the tracking and reward system and with the third party vendor, unless the source is already registered in the systems. The tracking and reward system is configured to reward the source of the third token ID, the second token ID, and the first token ID associated with the token.

In one embodiment of the invention, the third party vendor writes a token ID including a grand prize on a computer readable medium of a token. The grand prize may include a unique token ID. Once the computer readable medium including the grand prize token ID is in communication with the tracking and reward system and the third party vendor, the source of the grand prize token ID is notified and rewarded with a grand prize. The third party vendor system does not write a new token ID over the grand prize token ID. The token is configured to be kept and not exchanged for other tokens.

In operation of one embodiment of the invention, there is a management and tracking system for a plurality of exchangeable tokens. The system includes a tracking module configured to track a location of a token. The tracking module is in communication with a storage module. The storage module is configured to store location data and previous location data of the token as it is exchanged. The system includes an ID verification module configured to verify an ID of a token with a token database. The ID verification module is in communication with the reward module and is configured to verify an ID of a token and provide a reward to a source of the token over a network. The system also includes an ID writing module configured to write an ID for a token. The ID writing module is in communication with the communication module and is configured to transfer a token ID to a computer readable medium. The ID writing module is configured to write a unique grand reward ID. The system includes a control module configured to provide operational instructions to the modules of the system. The system further includes a communication module configured to send and receive data over a network.

In one embodiment of the invention, the system includes a reward module configured to provide a reward over a network. The system also includes a storage module configured to store data. The system further includes a management module configured to manage a plurality of exchangeable tokens. The management module manages metadata and token ID data of the tokens over a network. The management module is in communication with the reward module and is configured to provide a reward to a previous source of the token.

In operation of one embodiment of the invention, there is a non-transitory computer readable medium that includes instructions for performing the steps of sending a first token ID to a management and tracking system over a network. The instructions include sending token ID data and user metadata to a management and tracking system over a network. The instructions also include receiving a second token ID from a management and tracking system over a network. The instructions include overwriting the first token ID with the second token ID and storing the second token ID on the computer readable medium. The instructions include storing the first token ID and the second token ID. The instructions further include receiving a unique ID.

FIG. 6 is a reward protocol chart, according to one embodiment of the invention. There is shown a reward protocol chart configured to diagram reward payout. In particular, there may be a system that tracks processing of tokens such that the system is able to determine the number of prior users that have processed a particular token. Such may be accomplished by writing data to the token and/or by tracking usage of a particular token by a token ID or other method. As a token is processed, the user processing the token is provided a reward based on the chart.

Accordingly, in the illustrated example, if the user is the first user to process the token, that user is awarded 100 points. If the user is the second through X−1 user (where X may be a predetermined number), a reward is selected from a Reward Pool. Selection of the reward may be random, system determined, and/or user determined. Such may involve games of skill or chance. Wherein the user is the Xth user, the user receives a grand reward and further users receive no reward (null) or a post-grand prize reward of some kind. Accordingly, users are incentivized to continue trading, exchanging, and/or otherwise acquiring and processing tokens in the pursuit of the grand reward.

FIG. 7 is a prior user reward protocol chart, according to one embodiment of the invention. There is shown a prior user reward protocol chart configured to diagram prior user reward payout. In particular, there may be a system that tracks processing of tokens such that the system is able to associate processing of a token by one user with the account of another user, such as but not limited to a first processor or a user that may have originally received or distributed the token (such as but not limited to a retailer having an account).

Accordingly, in the illustrated example, the first user is provided with no reward but is then associated with the token such that further processing of the token generates associated rewards. As the next user (2^{nd}) processes the token, the first user is provided a reward selected from a Prior User Reward Pool (which may be selected in a manner similar to selection from the Reward Pool of FIG. 6) and this continues for each occurrence of token processing for that token until Y−1 processes have occurred (wherein Y is a predetermined number). At the Yth processing, the first user receives a grand award or other special treatment and further processing of the token either produce no (null) reward or a post-grand prize reward.

Rewards may include money or money equivalents (online cash, barter dollars, credits, etc), access to functions and/or data (media, statistics, demographics, other users, more features, greater functionality, customization levels, virtual objects, and the like and combinations thereof), permissions, trips, and etc.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although FIG. 1 illustrates a token associated with an article of clothing, it is understood that the token may be associated with any number of a plethora of products and/or services and is not limited to shirts, clothing, or even items for purchase through retail stores.

Additionally, although the figures illustrate particular reward charts, it is understood that differing rewards may be provided, that selection of those rewards may be different than as shown, the number of levels of rewards may differ, the granularity of the rewards may differ, the consistency of rewarding may be less, and that any selectable or determined portion of the reward chart may be randomized or otherwise variable or varying from that shown.

It is also envisioned that additional steps, functions, procedures and the like may be included in any of the methods described herein.

It is expected that there could be numerous variations of the design of this invention. An example is that the token may be a toy, a card, an article of clothing, and/or etc. In another example, the steps described herein may occur in orders different from those described and/or illustrated.

Finally, it is envisioned that the components of the device may be constructed of a variety of materials, including but not limited to plastic, ceramic, metal, mineral, fiber, composite, resin, wood, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of managing and tracking a plurality of tokens, comprising the steps of:
a) distributing a plurality of tokens including computer readable medium, each medium including a first token ID;
b) receiving a first token ID;
c) receiving user metadata from a source of the first token ID;
d) registering the user metadata in association with the first token ID;
e) sending a second token ID to the source of the first token ID;
f) instructing a user to share the token including the second token ID;
g) receiving the second token ID;
h) receiving user metadata from a source of the second token ID;
i) registering the user metadata in association with the second token ID; and
j) providing a reward to the source of the second token ID.

2. The method of claim 1, further comprising the step of providing a third token ID to the source of the second token ID.

3. The method of claim 1, further comprising the step of writing the second token ID to the computer readable medium.

4. The method of claim 1, further comprising the step of providing a grand prize to a source.

5. The method of claim 1, further comprising the step of providing a reward to the source of the first token ID after receiving user metal data from the source of the second token ID.

6. The method of claim 1, further comprising the step of distributing the plurality of tokens with a consumer good.

7. The method of claim 1, further comprising the step of writing a unique token ID to the computer readable medium.

8. The method of claim 1, further comprising the step of associating metadata from the source of the second token ID with the metadata of the source of the first token ID.

9. A management and tracking system for a plurality of exchangeable tokens, comprising:
a) a tracking module configured to track a location of a token;
b) an ID verification module configured to verify an ID of a token with a token database;
c) an ID writing module configured to write an ID for a token;
d) a control module configured to provide operational instructions to the modules of the system;
e) a communication module configured to send and receive data over a network;
f) a reward module configured to provide a reward over a network;
g) a storage module configured to store data; and
h) a management module configured to manage a plurality of exchangeable tokens, wherein the management module manages metadata and ID data of the tokens over a network.

10. The system of claim 9, wherein the tracking module is in communication with the storage module and is configured to track the location and previous locations of the token as it is exchanged.

11. The system of claim 9, wherein the ID writing module is in communication with the communication module and is configured to transfer a token ID to a computer readable medium.

12. The system of claim 9, wherein ID verification module is in communication with the reward module and is configured to verify an ID of a token and provide a reward to a source of the token over a network.

13. The system of claim 9, wherein the ID writing module is configured to write a unique grand reward ID.

14. The system of claim 9, wherein the management module is in communication with the reward module and is configured to provide a reward to a previous source of the token.

15. A non-transitory computer readable medium including instructions for execution on a computing device for performing the steps of:
a) sending a first token ID to a management and tracking system over a network;
b) sending metadata to a management and tracking system over a network;
c) receiving a second token ID from a management and tracking system over a network;
d) overwriting the first token ID with the second token ID; and
e) storing the second token ID.

16. The medium in claim 15, further comprising the instruction of storing the first token ID and the second token ID.

17. The medium of claim 15, further comprising the instruction of receiving a unique ID.
